(19) United States
(12) Patent Application Publication
(10) Pub. No.: US 2023/0157445 A1
(43) Pub. Date: May 25, 2023

(54) Systems, Methods and Apparatus for Lift Top Coffee Table having Concealed Locking Top Compartment

(71) Applicant: James Welsley Abbott, El Lago, TX (US)

(72) Inventor: James Wesley Abbott, El Lago, TX (US)

(21) Appl. No.: 17/535,571

(22) Filed: Nov. 25, 2021

(51) Int. Cl. A47B 21/04; G06F 1/16

(52) U.S. Cl. CPC A47B 21/04; G06F 1/1601; A47B 2200/0084

(57) ABSTRACT

Systems, methods and apparatus are provided through which a coffee table has a hidden pop-up compartment that encloses and deploys user computer equipment.

### FIELD OF THE INVENTION

This invention relates generally to furniture, and more particularly to computer stands.

### BACKGROUND OF THE INVENTION

As a result of the great increase in work-from-home that has occurred recently, the organizing, arranging, storing and deploying of computer equipment has become more important in residences that have not been organized and arranged to accommodate long-term, all-day use of computers. In particular, storing computers in residences that are small or whose decor does not aesthetically match computer, and then easily, quickly and efficiently deploying the equipment for use is a big problem

The U.S. Pat. No. 5,503,086 discloses a table with a movable top surface, but the table in U.S. Pat. No. 5,503,086 does not work well for the purposes intended in this disclosure.

### BRIEF DESCRIPTION OF THE INVENTION

The above-mentioned shortcomings, disadvantages and problems are addressed herein, which will be understood by reading and studying the following specification.

In one aspect, a lift top coffee table includes a base having a bottom and four adjacent sides; a fold-down keyboard tray having a bottom and four adjacent sides and being movable between a closed position, wherein the fold-down keyboard tray is horizontally disposed adjacent and above the base, and an open position, in which the fold-down keyboard tray is horizontally disposed above and forward of the base; a four-bar linkage apparatus comprising a fold-down keyboard tray mounting apparatus being pivotally interconnected to a front pivot link at a first pivot, and being further pivotally interconnected to a rear pivot link at a second pivot, the second pivot being positioned rearwardly from the first pivot, and a table base mounting apparatus rotatably fixed to the base, the front pivot link pivotally interconnected to the table base mounting apparatus at a third pivot, the rear pivot link pivotally interconnected to the table base mounting apparatus at a fourth pivot the second pivot being positioned rearwardly from the third pivot, the rear pivot link including an extension arm that extends generally rearwardly from the fourth pivot when the fold-down keyboard tray is in the open position; and a fold-down keyboard tray biasing apparatus attached to the extension arm of the rear pivot link and to the table base mounting apparatus for biasing the fold-down keyboard tray toward the open position.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a side-view block diagram of a lift top coffee table according to an implementation having a concealed locking top compartment.

FIG. 2 is an isometric left-side-view block diagram of a lift top coffee table according to an implementation having a concealed locking top compartment.

FIG. 3 is an isometric right-side-view block diagram of a lift top coffee table according to an implementation having a concealed locking top compartment.

FIG. 4 is a front-view block diagram of a lift top coffee table according to an implementation having a concealed locking top compartment.

FIG. 5 is a top-view block diagram of a lift top coffee table according to an implementation having a concealed locking top compartment.

FIG. 6 is an isometric right-side-bottom-view block diagram of a lift top coffee table according to an implementation having a concealed locking top compartment.

FIG. 7 is an isometric right-side-top-view block diagram of a lift top coffee table according to an implementation having a concealed locking top compartment.

FIG. 8 is an isometric left-side-top-view block diagram of a lift top coffee table according to an implementation having a concealed locking top compartment.

FIG. 9 is a right-side-view block diagram of a lift top coffee table according to an implementation having a concealed locking top compartment.

FIG. 10 is a top-view block diagram of a lift top coffee table according to an implementation having a concealed locking top compartment.

FIG. 11 is a front-view block diagram of a lift top coffee table according to an implementation having a concealed locking top compartment.

FIG. 12 is a bottom-view block diagram of a lift top coffee table according to an implementation having a concealed locking top compartment.

FIG. 13 is a block diagram of a lift-top-coffee-table-control computer, according to an implementation.

FIG. 14 is a block diagram of a data acquisition circuit of a lift-top-coffee-table-control computer, according to an implementation.

FIG. 15 is a block diagram of a lift-top-coffee-table-mobile device, according to an implementation.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, apparatus of embodiments are described. In the second section, hardware and the operating environment in conjunction with which embodiments may be practiced are described. Finally, in the third section, a conclusion of the detailed description is provided.

### Apparatus Embodiments

In the previous section, a system level overview of the operation of an embodiment was described. In this section, the particular apparatus of such an embodiment are described by reference to a series of diagrams.

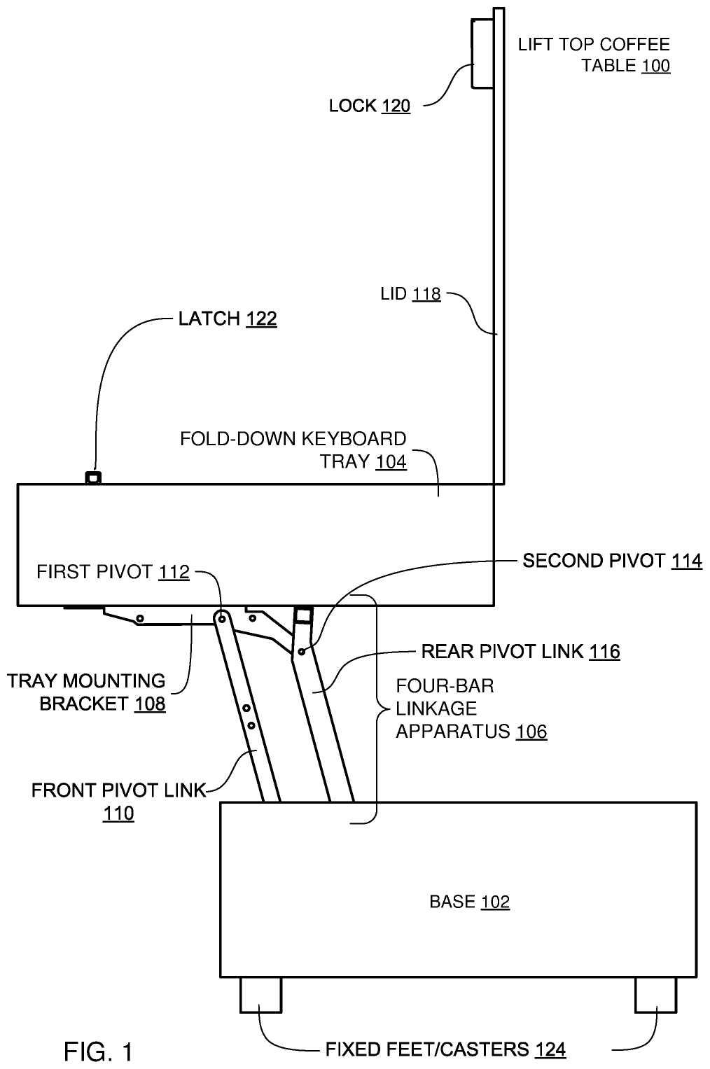

FIG. 1 is a side-view block diagram of a lift top coffee table 100 according to an implementation having a concealed locking top compartment.

The lift top coffee table 100 includes a base 102 having a bottom and four adjacent sides.

The lift top coffee table 100 also includes a fold-down keyboard tray 104 having a bottom and four adjacent sides and being movable between a closed position, wherein the fold-down keyboard tray 104 is horizontally disposed adjacent and above the base 102, and an open position, in which the fold-down keyboard tray 104 is horizontally disposed above and forward of the base 102. The fold-down keyboard tray 104 is also known as a concealed locking top compartment.

Some implementations of the lift top coffee table 100 also include an apparatus to moveably connect the fold-down keyboard tray 104 relative to the base 102, such as a four-bar linkage apparatus 106 or a slide rail that raises of lower the fold-down keyboard tray 104 over the base 102 without any horizontal movement.

A fold-down keyboard tray mounting bracket 108 is attached fixedly to the fold-down keyboard tray 104. The fold-down keyboard tray mounting bracket 108 is pivotally interconnected to the front pivot link 110 at a first pivot 112. The fold-down keyboard tray mounting bracket 108 is pivotally interconnected to the rear pivot link 116 at a second pivot 114, the second pivot 114 being positioned rearwardly from the first pivot 112 when the fold-down keyboard tray 104 is in the open position.

The four-bar linkage apparatus 106 includes a table base mounting apparatus (not shown) that is fixed to the base 102, the front pivot link 110 that is pivotally interconnected to the table base mounting apparatus (not shown) at a third pivot (not shown), the rear pivot link 116 is pivotally interconnected to the table base mounting apparatus at a fourth pivot (not shown) the second pivot (not shown) being positioned rearwardly from the first pivot (not shown) when the fold-down keyboard tray 104 is in the open position. The rear pivot link 116 includes an extension arm (not shown) that extends generally rearwardly from the second pivot (not shown) when the fold-down keyboard tray 104 is in the open position.

The lift top coffee table 100 also includes a fold-down keyboard tray biasing apparatus (not shown) attached to an extension arm (not shown) of the rear pivot link 116 and to the table base mounting apparatus (not shown) for biasing the fold-down keyboard tray 104 toward the open position.

A lid 118 is rotatably attached to the fold-down keyboard tray 104 via a hinge. The lid 118 includes a lock 120 that attaches to a latch 122 when the lid 118 is in the closed position. In some implementations of the lock 120, the lock 120 is an electronic lid. In some implementations of the electronic lock, the electronic lock is a RFID-based lock. The base 102 can also include a fixed feet or caster wheels 124.

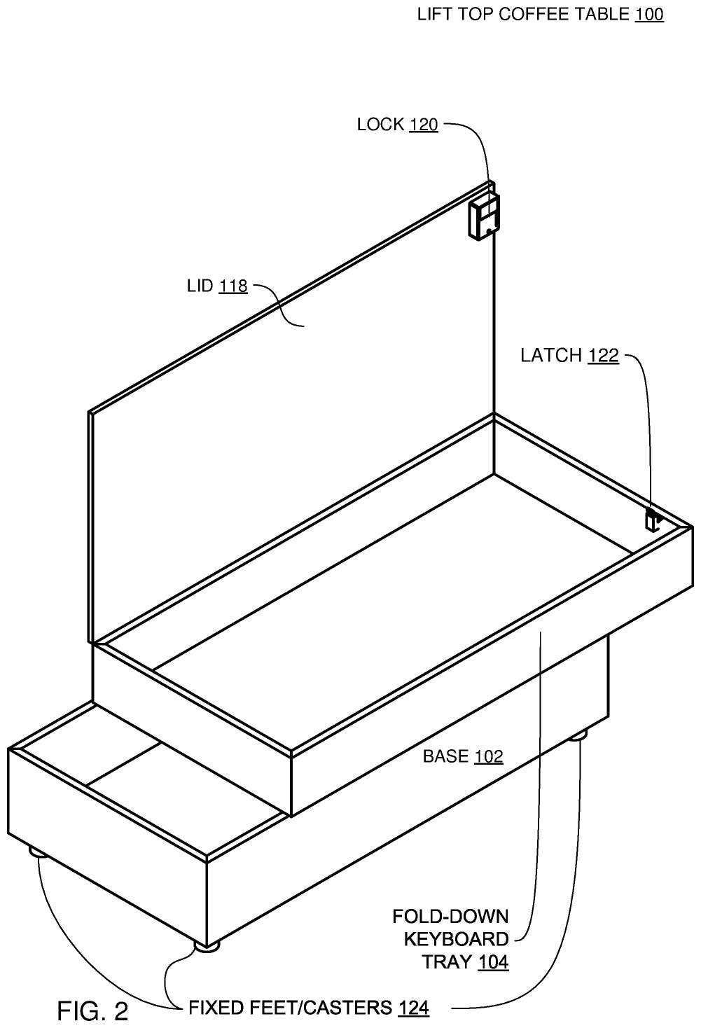

FIG. 2 is an isometric left-side-view block diagram of a lift top coffee table 100 according to an implementation having a concealed locking top compartment. The lift top coffee table 100 includes the base 102 having the bottom and four adjacent sides. The lift top coffee table 100 also includes the fold-down keyboard tray 104 having the bottom and four adjacent sides and being movable between the closed position, wherein the fold-down keyboard tray 104 is horizontally disposed adjacent and above the base 102, and the open position, in which the fold-down keyboard tray 104 is horizontally disposed above and forward of the base 102. The fold-down keyboard tray 104 is also known as the concealed locking top compartment. The lid 118 is rotatably attached to the fold-down keyboard tray 104 via the hinge. The lid 118 includes the lock 120 that attaches to the latch 122 when the lid 118 is in the closed position. The base 102 can also include the fixed feet or caster wheels 124.

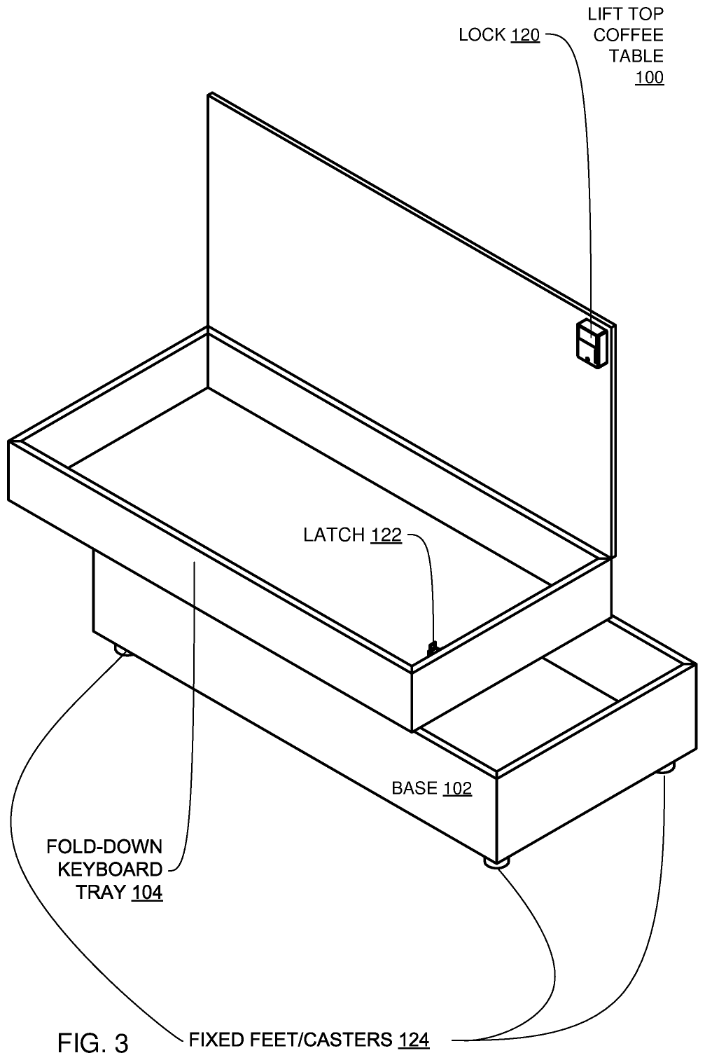

FIG. 3 is an isometric right-side-view block diagram of a lift top coffee table 100 according to an implementation having a concealed locking top compartment. The lift top coffee table 100 includes the base 102 having the bottom and four adjacent sides. The lift top coffee table 100 also includes the fold-down keyboard tray 104 having the bottom and four adjacent sides and being movable between the closed position, wherein the fold-down keyboard tray 104 is horizontally disposed adjacent and above the base 102, and the open position, in which the fold-down keyboard tray 104 is horizontally disposed above and forward of the base 102. The fold-down keyboard tray 104 is also known as the concealed locking top compartment. The lid 118 is rotatably attached to the fold-down keyboard tray 104 via the hinge. The lid 118 includes the lock 120 that attaches to the latch 122 when the lid 118 is in the closed position. The base 102 can also include the fixed feet or caster wheels 124.

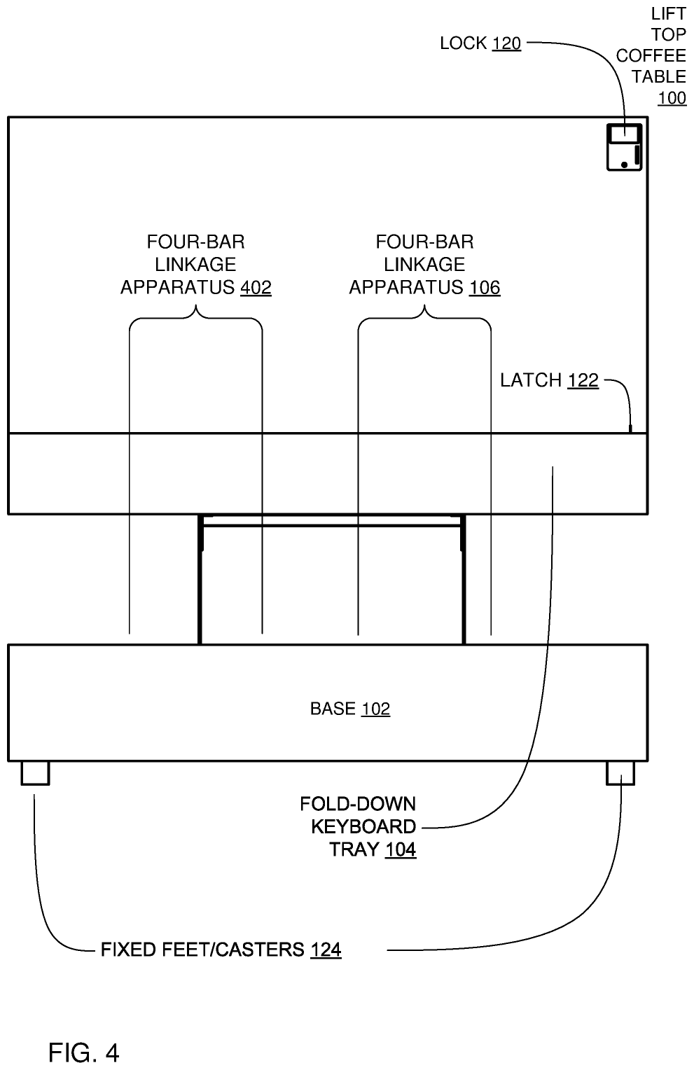

FIG. 4 is a front-view block diagram of a lift top coffee table 100 according to an implementation having a concealed locking top compartment. The lift top coffee table 100 includes the base 102 having the bottom and four adjacent sides. The lift top coffee table 100 also includes the fold-down keyboard tray 104 having the bottom and four adjacent sides and being movable between the closed position, wherein the fold-down keyboard tray 104 is horizontally disposed adjacent and above the base 102, and the open position, in which the fold-down keyboard tray 104 is horizontally disposed above and forward of the base 102. The fold-down keyboard tray 104 is also known as the concealed locking top compartment. The lift top coffee table 100 includes two four-bar linkages apparatus 106 and 402 that control the movement of the fold-down keyboard tray 104 between the open position and the closed position. As used herein, “four-bar linkage” refers to a series of four structures, or links, each of which is pivotally interconnected to two other links, so that the entire linkage has one degree of freedom of movement. Each four-bar linkage apparatus 106 and 402 includes a fold-down keyboard tray mounting bracket 108 that is a fold-down keyboard tray mounting bracket 108 attached to the rear pivot link 116, the front pivot link 110, and a fold-down keyboard tray mounting bracket 108. The lid 118 is rotatably attached to the fold-down keyboard tray 104 via the hinge. The lid 118 includes the lock 120 that attaches to the latch 122 when the lid 118 is in the closed position. The base 102 can also include the fixed feet or caster wheels 124.

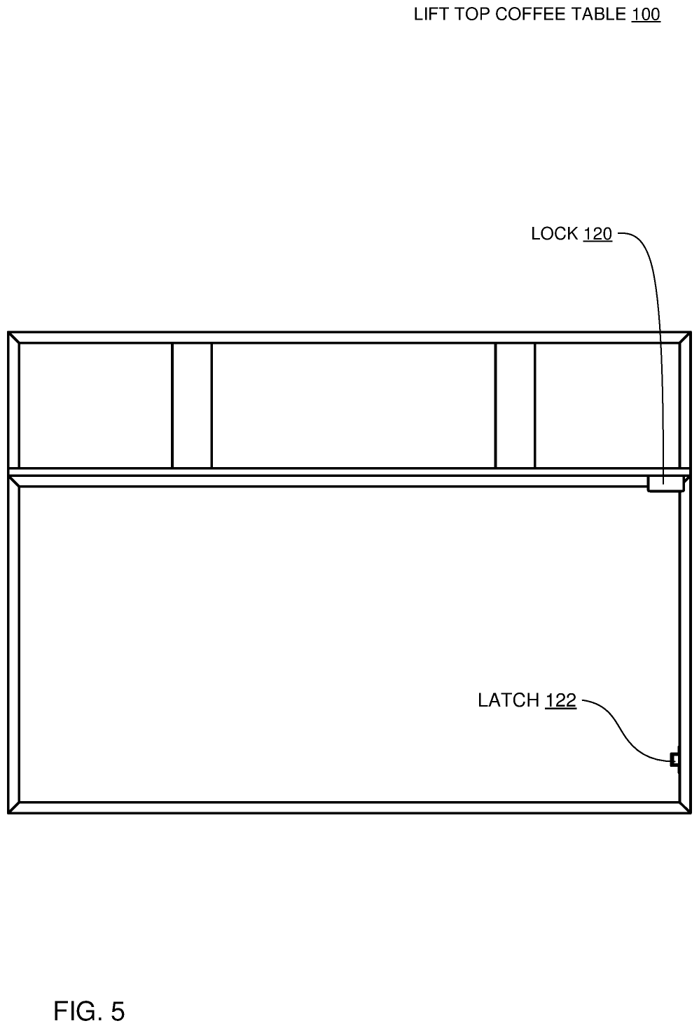

FIG. 5 is a top-view block diagram of a lift top coffee table 100 according to an implementation having a concealed locking top compartment. The lift top coffee table 100 includes the lock 120 that attaches to the latch 122 when the lid 118 is in the closed position.

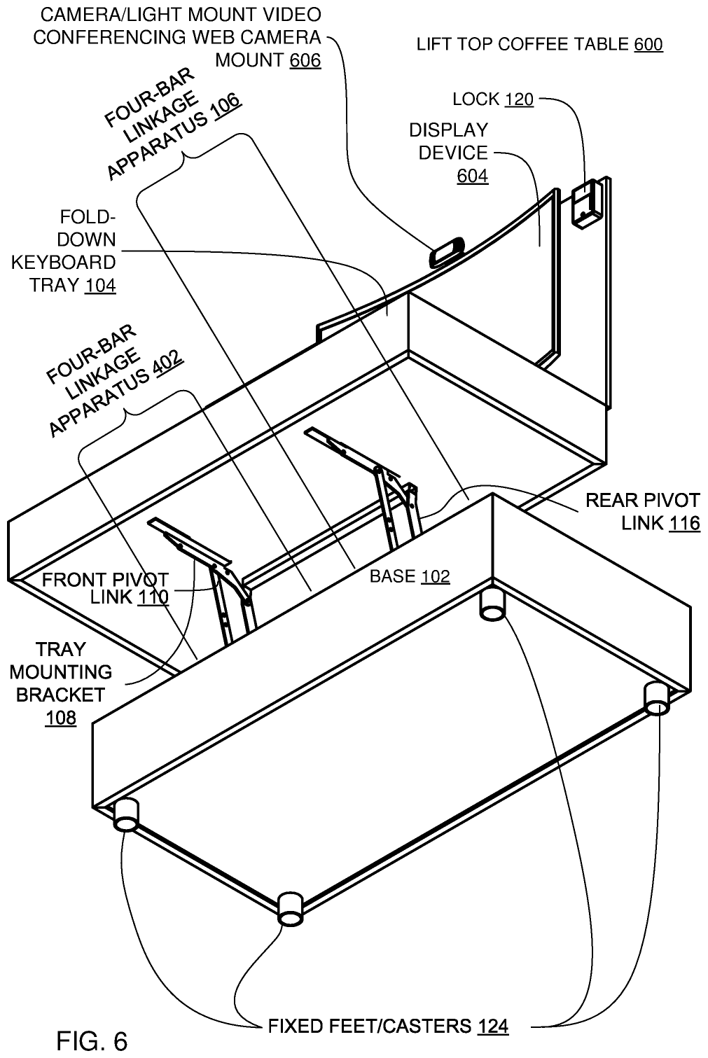

FIG. 6 is an isometric right-side-bottom-view block diagram of a lift top coffee table 600 according to an implementation having a concealed locking top compartment.

The lift top coffee table 600 includes a camera/light mount video conferencing web camera mount 602 and a display device 604 that are fixedly or removably attached to a lid 118.

The lift top coffee table 600 also includes a fold-down keyboard tray 104 having a bottom and four adjacent sides and being movable between a closed position, wherein the fold-down keyboard tray 104 is horizontally disposed adjacent and above the base 102, and an open position, in which the fold-down keyboard tray 104 is horizontally disposed above and forward of the base 102. The fold-down keyboard tray 104 is also known as a concealed locking top compartment.

The lift top coffee table 600 includes two four-bar linkage apparatus 106 and 402 that control the movement of the fold-down keyboard tray 104 between the open position and the closed position. As used herein, “four-bar linkage” refers to a series of four structures, or links, each of which is pivotally interconnected to two other links, so that the entire linkage has one degree of freedom of movement. Each four-bar linkage apparatus 106 and 402 includes a fold-down keyboard tray mounting bracket 108 that is attached to the rear pivot link 116, the front pivot link 110, and a fold-down keyboard tray 104. The lift top coffee table 600 includes the lock 120 that attaches to the latch 122 when the lid 118 is in the closed position. The base 102 can also include a fixed feet or caster wheels 124.

Some implementations of the lift top coffee table 600 include a camera/light mount video conferencing web camera mount 606.

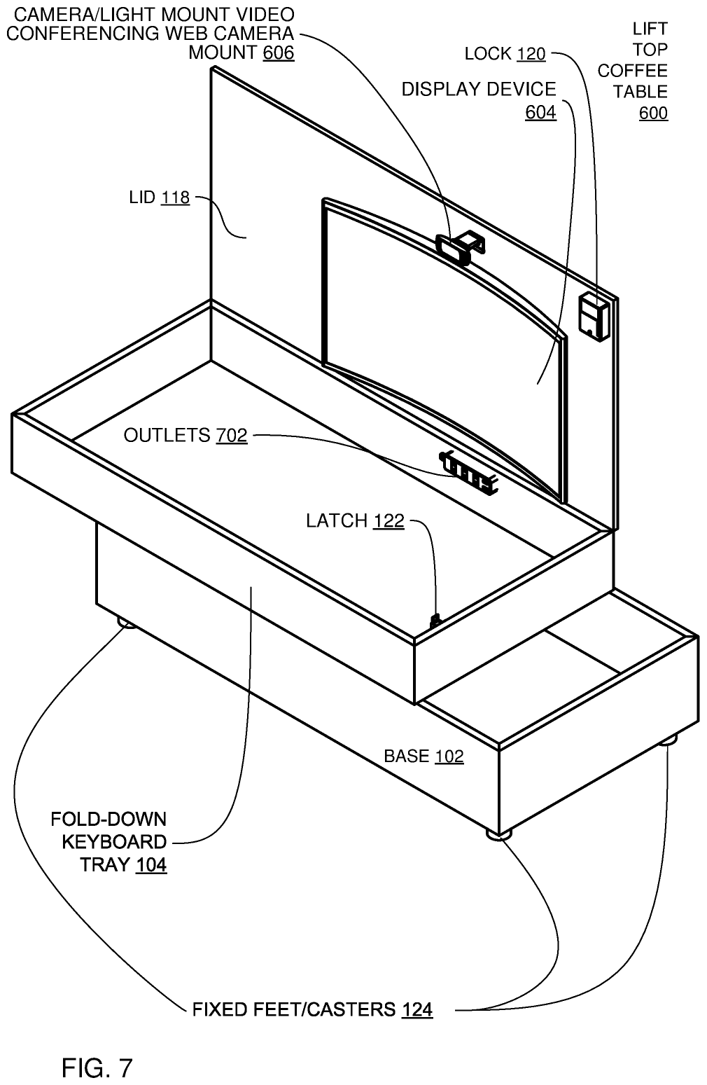

FIG. 7 is an isometric right-side-top-view block diagram of a lift top coffee table 600 according to an implementation having a concealed locking top compartment.

The lift top coffee table 600 includes a camera/light mount video conferencing web camera mount 602 and a display device 604 that are fixedly or removably attached to a lid 118. The lift top coffee table 600 includes the base 102 having the bottom and four adjacent sides. The lift top coffee table 600 also includes the fold-down keyboard tray 104 having the bottom and four adjacent sides and being movable between the closed position, wherein the fold-down keyboard tray 104 is horizontally disposed adjacent and above the base 102, and the open position, in which the fold-down keyboard tray 104 is horizontally disposed above and forward of the base 102. The fold-down keyboard tray 104 is also known as the concealed locking top compartment. The lid 118 is rotatably attached to the fold-down keyboard tray 104 via the hinge. The lid 118 includes the lock 120 that attaches to the latch 122 when the lid 118 is in the closed position. The base 102 can also include the fixed feet or caster wheels 124. The lift top coffee table 600 includes a display device 604 that is fixedly or removably attached to the lid 118.

Some implementations of the lift top coffee table 600 include outlets 702 that can include but is not limited to A/C power outlets, USB ports, DC power outlets and/or data ports. Some implementations of the lift top coffee table 600 include a camera/light mount video conferencing web camera mount 606.

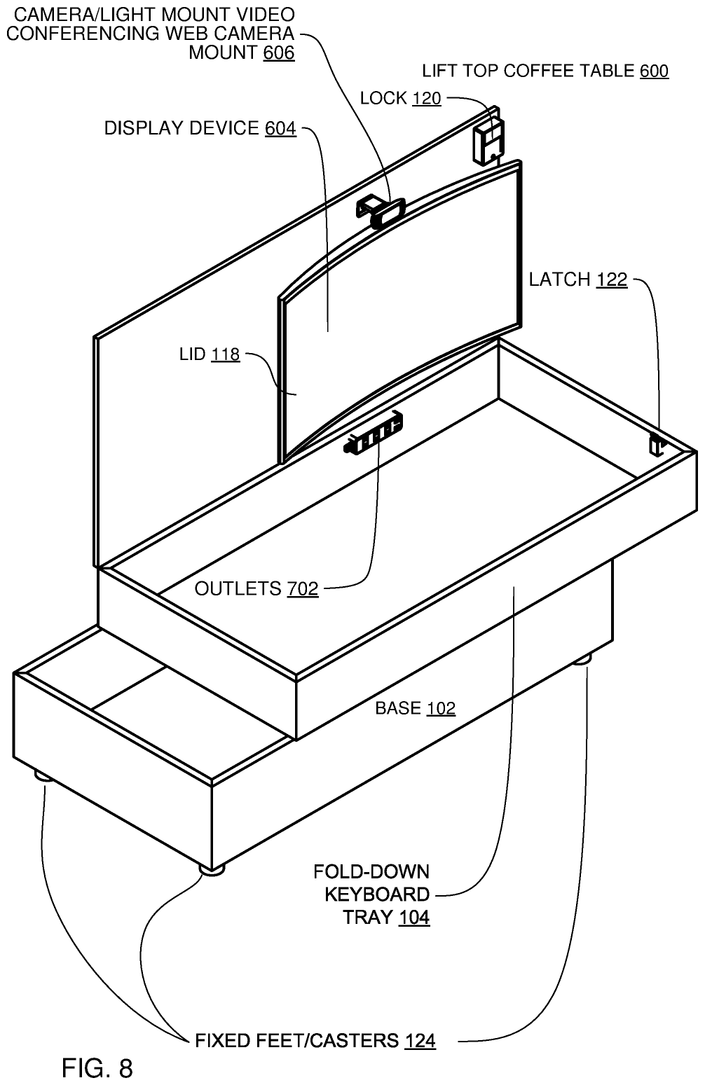

FIG. 8 is an isometric left-side-top-view block diagram of a lift top coffee table 600 according to an implementation having a concealed locking top compartment.

The lift top coffee table 600 includes a camera/light mount video conferencing web camera mount 602 and a display device 604 that are fixedly or removably attached to a lid 118. The lift top coffee table 600 includes the base 102 having the bottom and four adjacent sides. The lift top coffee table 600 also includes the fold-down keyboard tray 104 having the bottom and four adjacent sides and being movable between the closed position, wherein the fold-down keyboard tray 104 is horizontally disposed adjacent and above the base 102, and the open position, in which the fold-down keyboard tray 104 is horizontally disposed above and forward of the base 102. The fold-down keyboard tray 104 is also known as the concealed locking top compartment. The lid 118 is rotatably attached to the fold-down keyboard tray 104 via the hinge. The lid 118 includes the lock 120 that attaches to the latch 122 when the lid 118 is in the closed position. The base 102 can also include the fixed feet or caster wheels 124. The lift top coffee table 600 includes a display device 604 that is fixedly or removably attached to the lid 118.

Some implementations of the lift top coffee table 600 include outlets 702 that can include but is not limited to A/C power outlets, USB ports, DC power outlets and/or data ports. Some implementations of the lift top coffee table 600 include a camera/light mount video conferencing web camera mount 606.

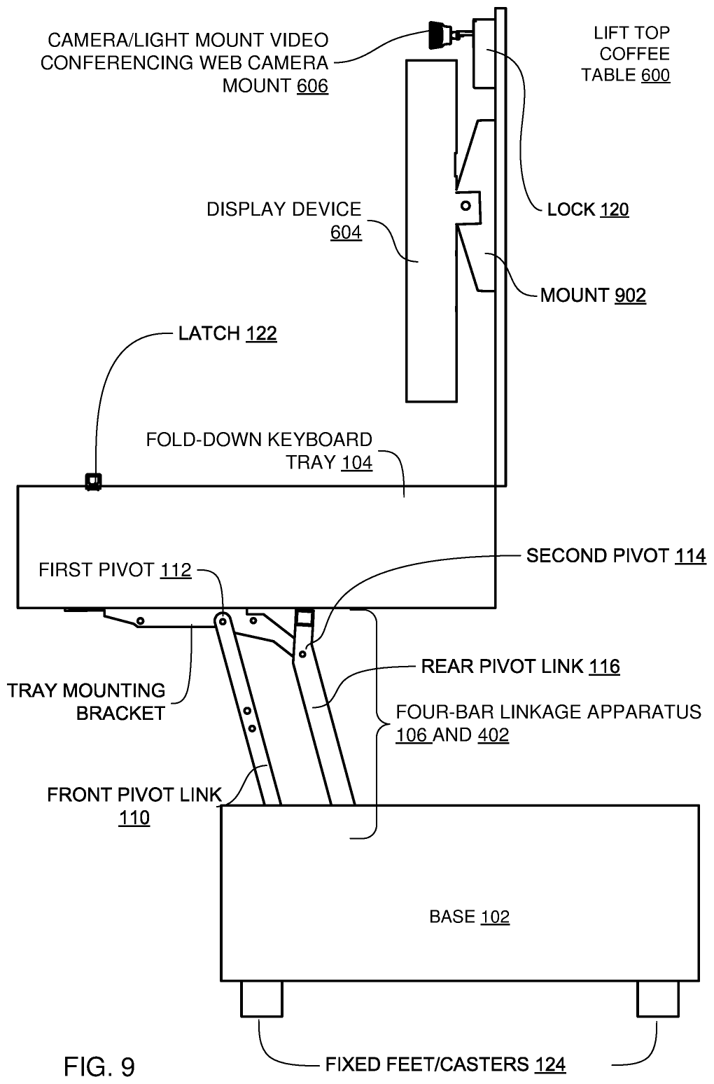

FIG. 9 is a right-side-view block diagram of a lift top coffee table 600 according to an implementation having a concealed locking top compartment.

The lift top coffee table 600 includes a camera/light mount video conferencing web camera mount 602 and a display device 604 that are fixedly or removably attached to a lid 118. The lift top coffee table 600 also includes a fold-down keyboard tray 104 having a bottom and four adjacent sides and being movable between a closed position, wherein the fold-down keyboard tray 104 is horizontally disposed adjacent and above the base 102, and an open position, in which the fold-down keyboard tray 104 is horizontally disposed above and forward of the base 102. The fold-down keyboard tray 104 is also known as a concealed locking top compartment.

The lift top coffee table 600 includes two four-bar linkage apparatus 106 and 402 that control the movement of the fold-down keyboard tray 104 between the open position and the closed position. As used herein, “four-bar linkage” refers to a series of four structures, or links, each of which is pivotally interconnected to two other links, so that the entire linkage has one degree of freedom of movement. Each four-bar linkage apparatus 106 and 402 includes a fold-down keyboard tray mounting bracket 108 that is attached to the rear pivot link 116, the front pivot link 110, and a fold-down keyboard tray 104. The lift top coffee table 600 includes the lock 120 that attaches to the latch 122 when the lid 118 is in the closed position. The base 102 can also include a fixed feet or caster wheels 124.

Some implementations of the lift top coffee table 600 include a mount 902 for the display device 604.

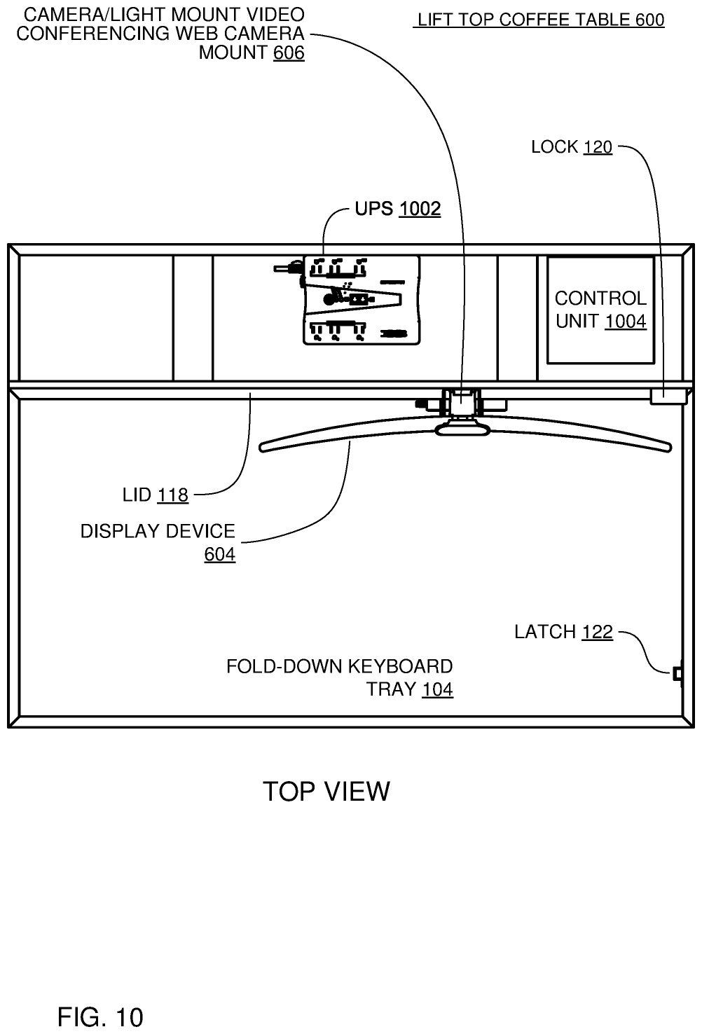

FIG. 10 is a top-view block diagram of a lift top coffee table 600 according to an implementation having a concealed locking top compartment.

The lift top coffee table 600 includes a camera/light mount video conferencing web camera mount 602 and a display device 604 that are fixedly or removably attached to a lid 118. The lift top coffee table 600 also includes the fold-down keyboard tray 104 having the bottom and four adjacent sides and being movable between the closed position, wherein the fold-down keyboard tray 104 is horizontally disposed adjacent and above the base 102, and the open position, in which the fold-down keyboard tray 104 is horizontally disposed above and forward of the base 102. The fold-down keyboard tray 104 is also known as the concealed locking top compartment. The lid 118 is rotatably attached to the fold-down keyboard tray 104 via the hinge. The lid 118 includes the lock 120 that attaches to the latch 122 when the lid 118 is in the closed position. The lift top coffee table 600 includes a display device 604 that is fixedly or removably attached to the lid 118.

Some implementations of the lift top coffee table 600 include an uninterruptable power supply (UPS) 1002 that is electrically coupled to electrical devices in the lift top coffee table 600, such as the display device 604, provides temporary back up power. Some implementations of the UPS 1002 include a surge protector. The UPS 1002 devices work independently, providing power when the main power supply fails. The UPS 1002 protects users as well as devices during disrupted power. The UPS 1002 delivers power almost instantly when the main power ceases, allowing for very little if any interruption in power at all. The power supplied tends to come from batteries, supercapacitors or flywheels.

Some implementations of the lift top coffee table 600 include a camera/light mount video conferencing web camera mount 606.

Some implementations of the lift top coffee table 600 include a control unit 1004, such as the lift-top-coffee-table-control computer 1300 or the lift-top-coffee-table-mobile device 1500.

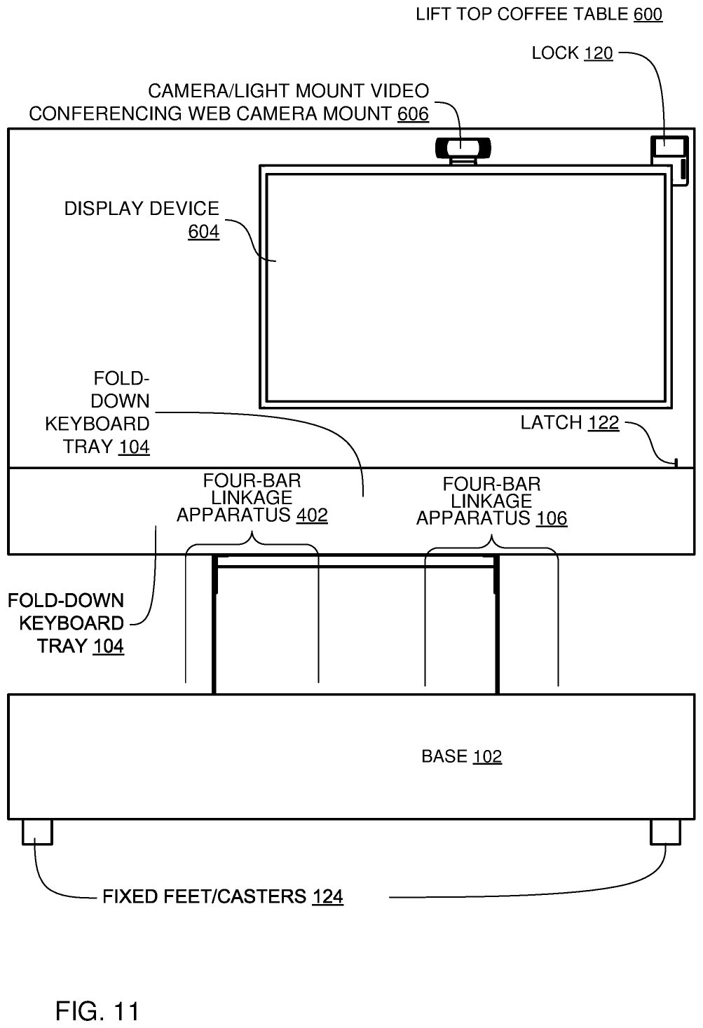

FIG. 11 is a front-view block diagram of a lift top coffee table 600 according to an implementation having a concealed locking top compartment.

The lift top coffee table 600 includes a camera/light mount video conferencing web camera mount 602 and a display device 604 that are fixedly or removably attached to a lid 118. The lift top coffee table 600 also includes a fold-down keyboard tray 104 having a bottom and four adjacent sides and being movable between a closed position, wherein the fold-down keyboard tray 104 is horizontally disposed adjacent and above the base 102, and an open position, in which the fold-down keyboard tray 104 is horizontally disposed above and forward of the base 102. The fold-down keyboard tray 104 is also known as a concealed locking top compartment.

The lift top coffee table 600 includes two four-bar linkage apparatus 106 and 402 that control the movement of the fold-down keyboard tray 104 between the open position and the closed position. As used herein, “four-bar linkage” refers to a series of four structures, or links, each of which is pivotally interconnected to two other links, so that the entire linkage has one degree of freedom of movement. The lift top coffee table 600 includes the lock 120 that attaches to the latch 122 when the lid 118 is in the closed position. The base 102 can also include a fixed feet or caster wheels 124.

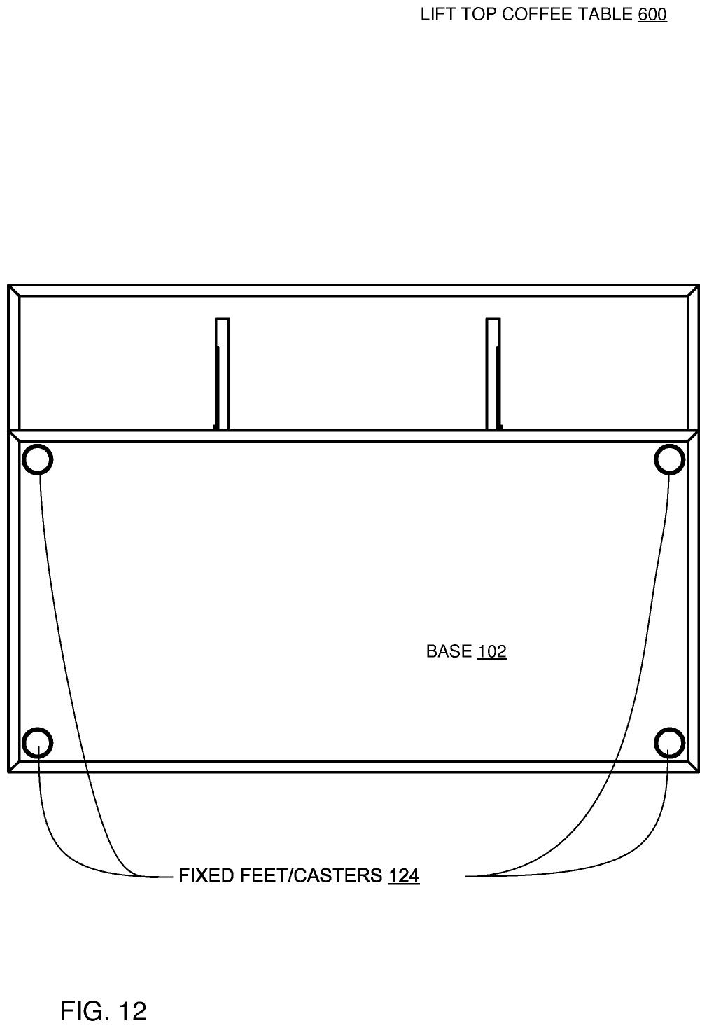

FIG. 12 is a bottom-view block diagram of a lift top coffee table 600 according to an implementation having a concealed locking top compartment. The lift top coffee table 600 includes the base 102 that can also include a fixed feet or caster wheels 124.

Some implementations of the lift top coffee table 600 include a camera/light mount video conferencing web camera mount 606.

### Hardware and Operating Environment

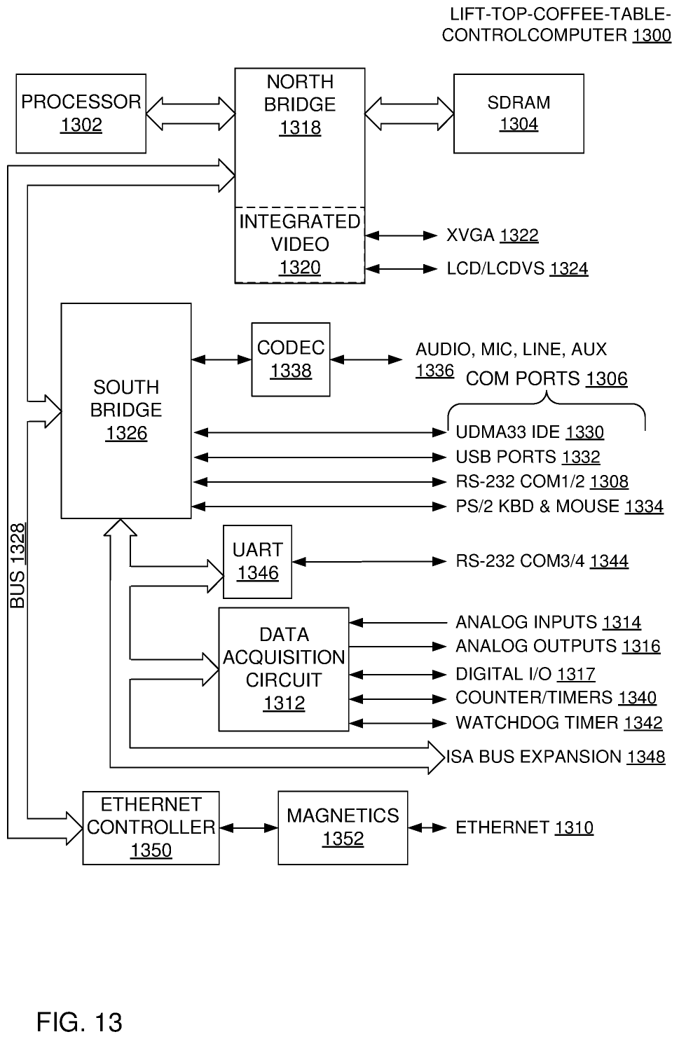

FIG. 13 is a block diagram of a lift-top-coffee-table-control computer 1300, according to an implementation. The lift-top-coffee-table-control computer 1300 includes a processor 1302 (such as a Pentium III processor from Intel Corp. in this example) which includes dynamic and static ram and non-volatile program read-only-memory (not shown), operating memory 1304 (SDRAM in this example), communication ports 1306 (e.g., RS-232 COM1/2 1308 or Ethernet 1310), a data acquisition circuit 1312 with analog inputs 1314, analog output 1316 and digital I/O port(s) 1317.

In some implementations of the lift-top-coffee-table-control computer 1300, the processor 1302 and the operating memory 1304 are coupled through a bridge 1318. In some implementations of the lift-top-coffee-table-control computer 1300, the bridge 1318 includes a video port 1320 having display outputs 1322 and 1324.

In some implementations of the lift-top-coffee-table-control computer 1300, the communication ports 1306 are coupled through a bridge 1326 and a bus 1328 to the bridge 1318. In some implementations of the lift-top-coffee-table-control computer 1300, the RS-232 1308 communication port 1306 also includes an integrated drive electronics (IDE) port 1330 such as an ultra direct memory access 33 (UDMA33) port, and universal serial bus (USB) ports 1332, and a PS/2 keyboard and mouse port 1334. In some implementations of the lift-top-coffee-table-control computer 1300, a port 1336 for audio, microphone, line and auxiliary devices is coupled through a coder/decoder (CODEC) 1338 to the bridge 1326.

In some implementations of the lift-top-coffee-table-control computer 1300, the data acquisition circuit 1312 is also coupled to counter/timer ports 1340 and watchdog timer ports 1342. In some implementations of the lift-top-coffee-table-control computer 1300, an RS-232 port 1344 is coupled through a universal asynchronous receiver/transmitter (UART) 1346 to the bridge 1326.

In some implementations of the lift-top-coffee-table-control computer 1300, an industry standard architecture (ISA) bus expansion port 1348 is coupled to the bridge 1326. In some implementations of the lift-top-coffee-table-control computer 1300, the Ethernet port 1310 is coupled to the bus 1328 through an Ethernet controller 1350 and a magnetics 1352.

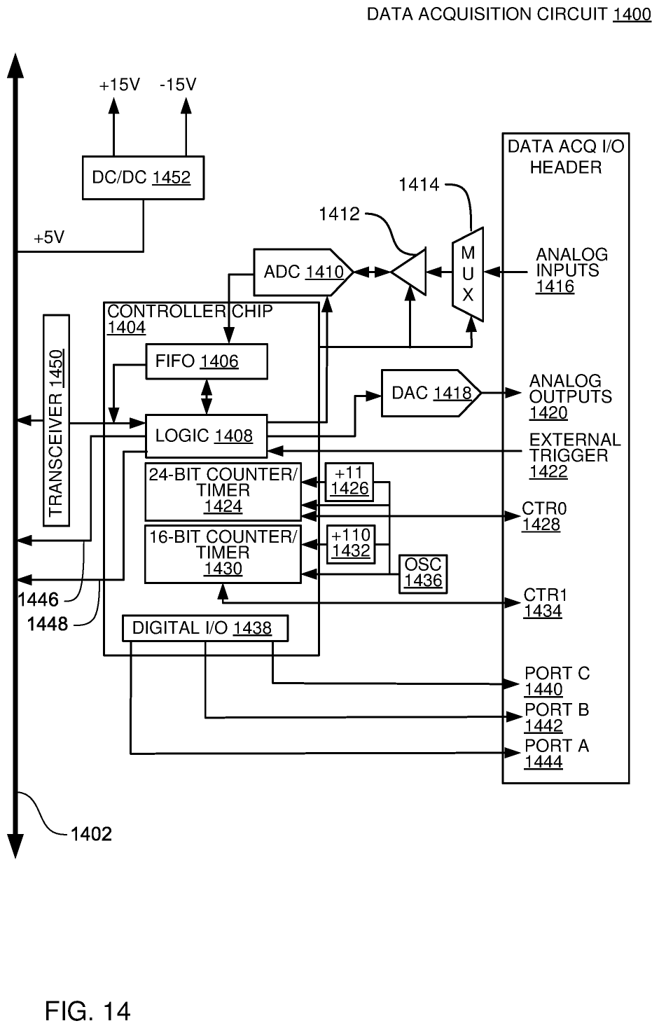

FIG. 14 is a block diagram of a data acquisition circuit 1400 of a lift-top-coffee-table-control computer, according to an implementation. The data acquisition circuit 1400 is one example of the data acquisition circuit 1312 in FIG. 13 above. Some implementations of the data acquisition circuit 1400 provide 16-bit A/D performance with input voltage capability up to +/−10V, and programmable input ranges.

The data acquisition circuit 1400 includes a bus 1402, such as a conventional PC/104 bus. The data acquisition circuit 1400 is operably coupled to a controller chip 1404. Some implementations of the controller chip 1404 include an analog/digital first-in/first-out (FIFO) buffer 1406 that is operably coupled to controller logic 1408. In some implementations of the data acquisition circuit 1400, the FIFO 1406 receives signal data from and analog/digital converter (ADC) 1410, which exchanges signal data with a programmable gain amplifier 1412, which receives data from a multiplexer 1414, which receives signal data from analog inputs 1416.

In some implementations of the data acquisition circuit 1400, the controller logic 1408 sends signal data to the ADC 1410 and a digital/analog converter (DAC) 1418. The DAC 1418 sends signal data to analog outputs. In some implementations of the data acquisition circuit 1400, the controller logic 1408 receives signal data from an external trigger 1422.

In some implementations of the data acquisition circuit 1400, the controller chip 1404 includes a 24-bit counter/timer 1424 that receives signal data from a +10 component 1426 and exchanges signal data with a “CTR 0” 1428. In some implementations of the data acquisition circuit 1400, the controller chip 1404 includes a 16-bit counter/timer 1430 that receives signal data from a +100 component 1432 and exchanges signal data with a “CTR 1” 1428. The 24-bit counter/timer 1424, the +10 component 1426, the 16-bit counter/timer 1430 and the +100 component 1432 all receive signal data from a oscillator (OSC) 1436.

In some implementations of the data acquisition circuit 1400, the controller chip 1404 includes a digital input/output (I/O) component 1438 that sends digital signal data to “port C” 1440, “port B” 1442 and “port A” 1444.

In some implementations of the data acquisition circuit 1400, the controller logic 1408 sends signal data to the bus 1402 via a control line 1446 and an interrupt line 1448. In some implementations of the data acquisition circuit 1400, the controller logic 1408 exchanges signal data to the bus 1402 via a transceiver 1450. In some implementations of the data acquisition circuit 1400, the bus supplies +5 volts of electricity to a DC-to-DC converter 1452, that in turn supplies +15V and −15V of electricity.

Some implementations of the data acquisition circuit 1400 include 4 14-bit D/A channels, 24 programmable digital I/O lines, and two programmable counter/timers. Placement of the analog circuitry away from the high-speed digital logic ensures low-noise performance for important applications. Some implementations of the data acquisition circuit 1400 are fully supported by operating systems that can include, but are not limited to, DOS™, Linux™, RTLinux™, QNX™, Windows 98/NT/2000/XP/CE™, Forth™, and VxWorks™ to simplify application development.

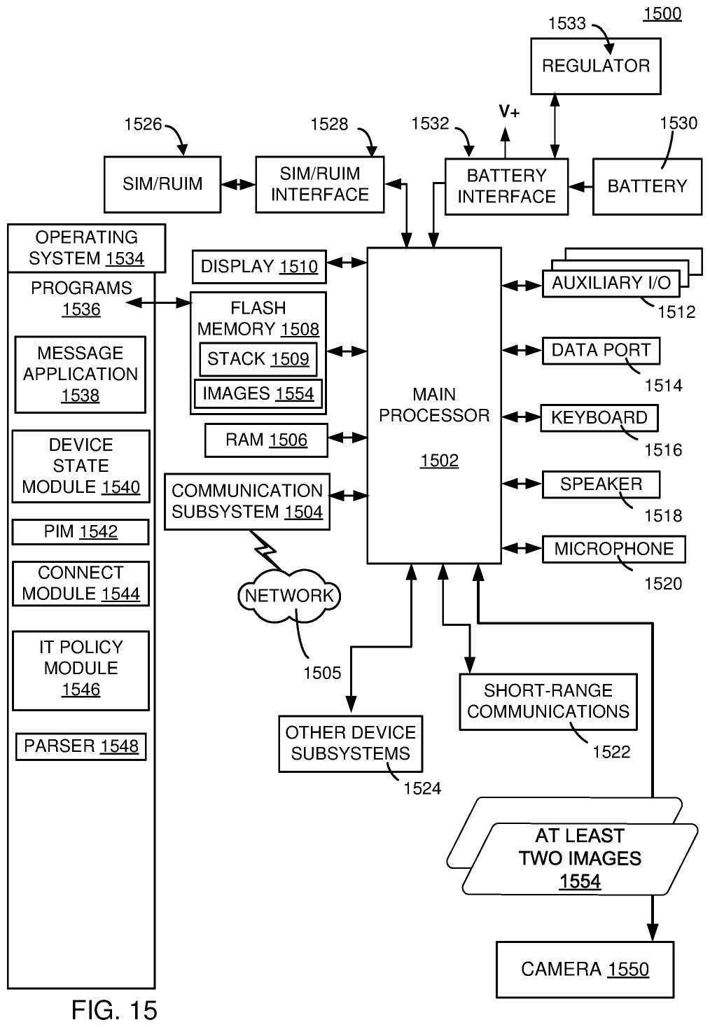

FIG. 15 is a block diagram of a lift-top-coffee-table-control mobile device 1500, according to an implementation. The lift-top-coffee-table-control mobile device 1500 includes a number of components such as a main processor 1502 that controls the overall operation of the lift-top-coffee-table-control mobile device 1500. Communication functions, including data and voice communications, are performed through a communication subsystem 1504. The communication subsystem 1504 receives messages from and sends messages to a wireless network 1505. In this exemplary implementation of the lift-top-coffee-table-control mobile device 1500, the communication subsystem 1504 is configured in accordance with the Global System for Mobile Communication (GSM), General Packet Radio Services (GPRS) standards, 3G, 4G, 5G and/or 6G. It will also be understood by persons skilled in the art that the implementations described herein are intended to use any other suitable standards that are developed in the future. The wireless link connecting the communication subsystem 1504 with the wireless network 1505 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 1505 associated with lift-top-coffee-table-control mobile device 1500 is a GSM/GPRS, 3G, 4G, 5G and/or 6G wireless network in one exemplary implementation, other wireless networks may also be associated with the lift-top-coffee-table-control mobile device 1500 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks, 3G, 4G, 5G and/or 6G. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 1502 also interacts with additional subsystems such as a Random Access Memory (RAM) 1506, a flash memory 1508, a display 1510, an auxiliary input/output (I/O) subsystem 1512, a data port 1514, a keyboard 1516, a speaker 1518, a microphone 1520, short-range communications 1522 and other device subsystems 1524.

Some of the subsystems of the lift-top-coffee-table-control mobile device 1500 perform communication-related functions, whereas other subsystems may provide “resident” or on-device functions. By way of example, the display 1510 and the keyboard 1516 may be used for both communication-related functions, such as entering a text message for transmission over the wireless network 1505, and device-resident functions such as a calculator or task list.

The lift-top-coffee-table-control mobile device 1500 can send and receive communication signals over the wireless network 1505 after required network registration or activation procedures have been completed. Network access is associated with a subscriber or user of the lift-top-coffee-table-control mobile device 1500. To identify a subscriber, the lift-top-coffee-table-control mobile device 1500 requires a SIM/RUIM card 1526 (i.e. Subscriber Identity Module or a Removable User Identity Module) to be inserted into a SIM/RUIM interface 1528 in order to communicate with a network. The SIM card or RUIM 1526 is one type of a conventional “smart card” that can be used to identify a subscriber of the lift-top-coffee-table-control mobile device 1500 and to personalize the lift-top-coffee-table-control mobile device 1500, among other things. Without the SIM card 1526, the lift-top-coffee-table-control mobile device 1500 is not fully operational for communication with the wireless network 1505. By inserting the SIM/RUIM card 1526 into the SIM/RUIM interface 1528, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM/RUIM card 1526 includes a processor and memory for storing information. Once the SIM/RUIM card 1526 is inserted into the SIM/RUIM interface 1528, it is coupled to the main processor 1502. In order to identify the subscriber, the SIM/RUIM card 1526 can include some user parameters such as an International Mobile Subscriber Identity (IMSI). An advantage of using the SIM/RUIM card 1526 is that a subscriber is not necessarily bound by any single physical mobile device. The SIM/RUIM card 1526 may store additional subscriber information for a mobile device as well, including datebook (or calendar) information and recent call information. Alternatively, user identification information can also be programmed into the flash memory 1508.

The lift-top-coffee-table-control mobile device 1500 is a battery-powered device and includes a battery interface 1532 for receiving one or more rechargeable batteries 1530. In one or more implementations, the battery 1530 can be a smart battery with an embedded microprocessor. The battery interface 1532 is coupled to a regulator 1533, which assists the battery 1530 in providing power V+ to the lift-top-coffee-table-control mobile device 1500. Although current technology makes use of a battery, future technologies such as micro fuel cells may provide the power to the lift-top-coffee-table-control mobile device 1500.

The lift-top-coffee-table-control mobile device 1500 also includes an operating system 1534 and modules 1536 to 1548 which are described in more detail below. The operating system 1534 and the modules 1536 to 1548 that are executed by the main processor 1502 are typically stored in a persistent store such as the flash memory 1508, which may alternatively be a read-only memory (ROM) or similar storage element (not shown). Those skilled in the art will appreciate that portions of the operating system 1534 and the modules 1536 to 1548, such as specific device applications, or parts thereof, may be temporarily loaded into a volatile store such as the RAM 1506. Other modules can also be included.

The subset of modules 1536 that control basic device operations, including data and voice communication applications, will normally be installed on the lift-top-coffee-table-control mobile device 1500 during its manufacture. Other modules include a message application 1538 that can be any suitable software program that allows a user of the lift-top-coffee-table-control mobile device 1500 to send and receive electronic messages. Various alternatives exist for the message application 1538 as is well known to those skilled in the art. Messages that have been sent or received by the user are typically stored in the flash memory 1508 of the lift-top-coffee-table-control mobile device 1500 or some other suitable storage element in the lift-top-coffee-table-control mobile device 1500. In one or more implementations, some of the sent and received messages may be stored remotely from the lift-top-coffee-table-control mobile device 1500 such as in a data store of an associated host system with which the lift-top-coffee-table-control mobile device 1500 communicates.

The modules can further include a device state module 1540, a Personal Information Manager (PIM) 1542, and other suitable modules (not shown). The device state module 1540 provides persistence, i.e. the device state module 1540 ensures that important device data is stored in persistent memory, such as the flash memory 1508, so that the data is not lost when the lift-top-coffee-table-control mobile device 1500 is turned off or loses power.

The PIM 1542 includes functionality for organizing and managing data items of interest to the user, such as, but not limited to, e-mail, contacts, calendar events, voice mails, appointments, and task items. A PIM application has the ability to send and receive data items via the wireless network 1505. PIM data items may be seamlessly integrated, synchronized, and updated via the wireless network 1505 with the mobile device subscriber's corresponding data items stored and/or associated with a host computer system. This functionality creates a mirrored host computer on the lift-top-coffee-table-control mobile device 1500 with respect to such items. This can be particularly advantageous when the host computer system is the mobile device subscriber's office computer system.

The lift-top-coffee-table-control mobile device 1500 also includes a connect module 1544, and an IT policy module 1546. The connect module 1544 implements the communication protocols that are required for the lift-top-coffee-table-control mobile device 1500 to communicate with the wireless infrastructure and any host system, such as an enterprise system, with which the lift-top-coffee-table-control mobile device 1500 is authorized to interface.

The connect module 1544 includes a set of APIs that can be integrated with the lift-top-coffee-table-control mobile device 1500 to allow the lift-top-coffee-table-control mobile device 1500 to use any number of services associated with the enterprise system. The connect module 1544 allows the lift-top-coffee-table-control mobile device 1500 to establish an end-to-end secure, authenticated communication pipe with the host system. A subset of applications for which access is provided by the connect module 1544 can be used to pass IT policy commands from the host system to the lift-top-coffee-table-control mobile device 1500. This can be done in a wireless or wired manner. These instructions can then be passed to the IT policy module 1546 to modify the configuration of the lift-top-coffee-table-control mobile device 1500. Alternatively, in some cases, the IT policy update can also be done over a wired connection.

The IT policy module 1546 receives IT policy data that encodes the IT policy. The IT policy module 1546 then ensures that the IT policy data is authenticated by the lift-top-coffee-table-control mobile device 1500. The IT policy data can then be stored in the flash memory 1506 in its native form. After the IT policy data is stored, a global notification can be sent by the IT policy module 1546 to all of the applications residing on the lift-top-coffee-table-control mobile device 1500. Applications for which the IT policy may be applicable then respond by reading the IT policy data to look for IT policy rules that are applicable.

The IT policy module 1546 can include a parser 1548, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 1546 can determine which applications are affected by the IT policy data and send a notification to only those applications. In either of these cases, for applications that are not being executed by the main processor 1502 at the time of the notification, the applications can call the parser or the IT policy module 1546 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 1546 sends an acknowledgement back to the host system to indicate that the IT policy data was received and successfully applied.

Other types of modules can also be installed on the lift-top-coffee-table-control mobile device 1500. These modules can be third party applications, which are added after the manufacture of the lift-top-coffee-table-control mobile device 1500. Examples of third party applications include games, calculators, utilities, etc.

The additional applications can be loaded onto the lift-top-coffee-table-control mobile device 1500 through at least one of the wireless network 1505, the auxiliary I/O subsystem 1512, the data port 1514, the short-range communications subsystem 1522, or any other suitable device subsystem 1524. This flexibility in application installation increases the functionality of the lift-top-coffee-table-control mobile device 1500 and may provide enhanced on-device functions, communication-related functions, or both. For example, secure communication applications may enable electronic commerce functions and other such financial transactions to be performed using the lift-top-coffee-table-control mobile device 1500.

The data port 1514 enables a subscriber to set preferences through an external device or software application and extends the capabilities of the lift-top-coffee-table-control mobile device 1500 by providing for information or software downloads to the lift-top-coffee-table-control mobile device 1500 other than through a wireless communication network. The alternate download path may, for example, be used to load an encryption key onto the lift-top-coffee-table-control mobile device 1500 through a direct and thus reliable and trusted connection to provide secure device communication.

The data port 1514 can be any suitable port that enables data communication between the lift-top-coffee-table-control mobile device 1500 and another computing device. The data port 1514 can be a serial or a parallel port. In some instances, the data port 1514 can be a USB port that includes data lines for data transfer and a supply line that can provide a charging current to charge the battery 1530 of the lift-top-coffee-table-control mobile device 1500.

The short-range communications subsystem 1522 provides for communication between the lift-top-coffee-table-control mobile device 1500 and different systems or devices, without the use of the wireless network 1505. For example, the subsystem 1522 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 1504 and input to the main processor 1502. The main processor 1502 will then process the received signal for output to the display 1510 or alternatively to the auxiliary I/O subsystem 1512. A subscriber may also compose data items, such as e-mail messages, for example, using the keyboard 1516 in conjunction with the display 1510 and possibly the auxiliary I/O subsystem 1512. The auxiliary subsystem 1512 may include devices such as: a touch screen, mouse, track ball, infrared fingerprint detector, or a roller wheel with dynamic button pressing capability. The keyboard 1516 is preferably an alphanumeric keyboard and/or telephone-type keypad. However, other types of keyboards may also be used. A composed item may be transmitted over the wireless network 1505 through the communication subsystem 1504.

For voice communications, the overall operation of the lift-top-coffee-table-control mobile device 1500 is substantially similar, except that the received signals are output to the speaker 1518, and signals for transmission are generated by the microphone 1520. Alternative voice or audio I/O subsystems, such as a voice message recording subsystem, can also be implemented on the lift-top-coffee-table-control mobile device 1500. Although voice or audio signal output is accomplished primarily through the speaker 1518, the display 1510 can also be used to provide additional information such as the identity of a calling party, duration of a voice call, or other voice call related information.

In some implementations, the lift-top-coffee-table-control mobile device 1500 includes a camera 1550 receiving a plurality of images 1554 from and examining pixel-values of the plurality of images 1554.

### CONCLUSION

A lift top coffee table is described. Although specific embodiments are illustrated and described herein, it will be appreciated by those of ordinary skill in the art that any arrangement which is calculated to achieve the same purpose may be substituted for the specific embodiments shown. This application is intended to cover any adaptations or variations. For example, although described in home residential terms, one of ordinary skill in the art will appreciate that implementations can be made in office or any other industrial furniture terms that provides the required function.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future lift top coffee table devices, different computers, and new coffee tables.

The terminology used in this application with respect to coffee table is meant to include all furniture environments and alternate technologies which provide the same functionality as described herein

I claim:

1. A lift top coffee table comprising:
a base having a bottom and four adjacent sides;
a fold-down keyboard tray having a bottom and four adjacent sides and being movable between a closed position, wherein the fold-down keyboard tray is horizontally disposed adjacent and above the base, and an open position, in which the fold-down keyboard tray is horizontally disposed above and forward of the base;
a four-bar linkage apparatus comprising a fold-down keyboard tray mounting apparatus being pivotally interconnected to a front pivot link at a first pivot, and being further pivotally interconnected to a rear pivot link at a second pivot, the second pivot being positioned rearwardly from the first pivot, and a table base mounting apparatus rotatably fixed to the base, the front pivot link pivotally interconnected to the table base mounting apparatus at a third pivot, the rear pivot link pivotally interconnected to the table base mounting apparatus at a fourth pivot the second pivot being positioned rearwardly from the third pivot, the rear pivot link including an extension arm that extends generally rearwardly from the fourth pivot when the fold-down keyboard tray is in the open position; and
a fold-down keyboard tray biasing apparatus attached to the extension arm of the rear pivot link and to the table base mounting apparatus for biasing the fold-down keyboard tray toward the open position.

2. A lift top coffee table comprising:
a base;
a fold-down keyboard tray being movable between a closed position and an open position;
a four-bar linkage apparatus comprising a fold-down keyboard tray mounting apparatus being pivotally interconnected to a front pivot link at a first pivot, and being further pivotally interconnected to a rear pivot link at a second pivot, the second pivot being positioned rearwardly from the first pivot, and a table base mounting apparatus rotatably fixed to the base, the front pivot link pivotally interconnected to the table base mounting apparatus at a third pivot, the rear pivot link pivotally interconnected to the table base mounting apparatus at a fourth pivot the second pivot being positioned rearwardly from the third pivot, the rear pivot link including an extension arm that extends generally rearwardly from the fourth pivot when the fold-down keyboard tray is in the open position; and
a fold-down keyboard tray biasing apparatus attached to the rear pivot link and to the table base mounting apparatus.

3. The lift top coffee table of claim 2 wherein:
the base further comprising a bottom and four adjacent sides.

4. The lift top coffee table of claim 2 wherein:
the fold-down keyboard tray further comprising a bottom and four adjacent sides.

5. The lift top coffee table of claim 2 wherein:
the fold-down keyboard tray biasing apparatus further comprising being attached to the extension arm of the rear pivot link and attached to the table base mounting apparatus for biasing the fold-down keyboard tray toward the open position.

6. The lift top coffee table of claim 2 wherein:
the fold-down keyboard tray further comprising being movable between the closed position, wherein the fold-down keyboard tray is horizontally disposed adjacent and above the base, and the open position, in which the fold-down keyboard tray is horizontally disposed above and forward of the base.

7. A lift top coffee table comprising:
a base;
a fold-down keyboard tray being movable between a closed position and an open position;
a four-bar linkage apparatus comprising a fold-down keyboard tray mounting apparatus being interconnected to a front pivot link, and a rear pivot link, and a table base mounting apparatus being attached to the base, the front pivot link being interconnected to the table base mounting apparatus, and the rear pivot link being interconnected to the table base mounting apparatus; and
a fold-down keyboard tray biasing apparatus attached to the rear pivot link and to the table base mounting apparatus.

8. The lift top coffee table of claim 7 wherein:
the base further comprising a bottom and four adjacent sides.

9. The lift top coffee table of claim 7 wherein:
the fold-down keyboard tray further comprising a bottom and four adjacent sides.

10. The lift top coffee table of claim 7 wherein:
the fold-down keyboard tray biasing apparatus further comprising being attached to an extension arm of the rear pivot link and attached to the table base mounting apparatus for biasing the fold-down keyboard tray toward the open position.

11. The lift top coffee table of claim 7 wherein:
the fold-down keyboard tray further comprising being movable between the closed position, wherein the fold-down keyboard tray is horizontally disposed adjacent and above the base, and the open position, in which the fold-down keyboard tray is horizontally disposed above and forward of the base.

13. The lift top coffee table of claim 7 wherein:
the fold-down keyboard tray mounting apparatus further comprising being pivotally interconnected to the front pivot link at a first pivot.

14. The lift top coffee table of claim 13 wherein:
the fold-down keyboard tray mounting apparatus further comprising being further pivotally interconnected to the rear pivot link at a second pivot, the second pivot being positioned rearwardly from the first pivot.

15. The lift top coffee table of claim 14 wherein:
the table base mounting apparatus further comprising being rotatably attached to the base.

16. The lift top coffee table of claim 15 wherein:
the front pivot link pivotally interconnected to the table base mounting apparatus at a third pivot.

17. The lift top coffee table of claim 16 wherein:
the rear pivot link pivotally interconnected to the table base mounting apparatus at a fourth pivot.

18. The lift top coffee table of claim 17 wherein:
the second pivot being positioned rearwardly from the third pivot.

19. The lift top coffee table of claim 18 wherein:
the rear pivot link including an extension arm that extends generally rearwardly from the fourth pivot when the fold-down keyboard tray is in the open position.
